(19) United States
(12) Patent Application Publication
(10) Pub. No.: US 2026/0247032 A1
(43) Pub. Date: Aug. 20, 2026

(54) IMAGE CAPTURING APPARATUS, CONTROL METHOD THEREOF, AND STORAGE MEDIUM

(71) Applicant: CANON KABUSHIKI KAISHA, Tokyo (JP)

(72) Inventor: HIROYUKI FURUMOCHI, Tokyo (JP)

(21) Appl. No.: 19/532,983

(22) Filed: Feb. 6, 2026

(30) Foreign Application Priority Data
Feb. 18, 2025 (JP) 2025-024487

(51) Int. Cl. H04N 23/667

(52) U.S. Cl. CPC H04N 23/667

(57) ABSTRACT

An image capturing apparatus comprises: an image sensor that captures a subject image and outputs an image signal; a determination unit that determines an exposure period and a sensitivity of the image sensor based on the image signal; and an actuation unit that actuates the image sensor in a first mode in which a moving image is captured at a predetermined image capture period, or in a second mode in which a still image can be captured while a moving image is captured at the image capture period, based on the exposure period and the sensitivity determined by the determination unit, wherein the determination unit determines a first exposure period, shorter than a maximum exposure period which is a partial period of the image capture period excluding a predetermined period, and a first sensitivity for moving image capture.

### BACKGROUND

### Field of the Technology

The present disclosure relates to an image capturing apparatus, a control method thereof, and a storage medium, and more particularly to a technique for capturing a still image while capturing a moving image.

### Description of the Related Art

There are digital cameras and electronic devices with camera functions (hereafter referred to as "image capturing apparatuses") that have live view (LV) functions, moving image capture functions, and still image capture functions.

In LV, images output from an image sensor at a predetermined frame rate are sequentially developed and displayed on a display device. In moving image capture, images output from the image sensor at a predetermined frame rate are developed and recorded as moving image files on recording media. In still image capture, images output from the image sensor are developed and recorded as still image files on recording media.

Some of these image capturing apparatuses capture still images while capturing moving images, and record the captured still images and moving images as moving image files and still image files, respectively. Hereinafter, capturing still images while capturing moving images will be referred to as "simultaneous moving and still image capture."

Japanese Patent Laid-Open No. 2007-221451 discloses a technique in which, in a case where a command to capture a still image is received during moving image capture, the moving image capture is temporarily stopped and still image capture is performed, then the missing frame of the moving image is interpolated using the captured still image.

Japanese Patent Laid-Open No. 2008-160171 discloses a technique in which, in a case where a command to capture a still image is received during moving image capture, one frame of the moving image is extracted as a still image.

However, while the still image capture disclosed in Japanese Patent Laid-Open No. 2007- 221451 can obtain a still image as intended by the user, because the moving image capture is temporarily stopped, the interpolated moving image may be unnatural due to changes in the subject, etc.

Furthermore, with the technology disclosed in Japanese Patent Laid-Open No. 2008-160171, in moving image capture, a relatively long exposure period is usually set to make the subject's movement appear smooth, so when a still image is extracted from the moving image, the subject in the obtained still image may appear blurred. This blurring is particularly noticeable when a subject is moving.

Furthermore, Japanese Patent Laid-Open No. 2018-74523 discloses a technique in which, when the readout speed from the image sensor is set in advance, moving image capture and still image capture are performed alternately, wherein the exposure period for the still image capture is set shorter than the exposure period for the moving image capture.

However, in the conventional technology disclosed in Japanese Patent Laid-Open No. 2018-74523, moving image capture and still image capture are performed alternately, so the frame rate of the moving image is half the readout rate from the image sensor. Therefore, the exposure period for still image capture and the exposure period for moving image capture cannot be set longer than half the frame rate of the moving image. Therefore, in a case of capturing a still image while capturing a moving image, there is a problem in that, depending on the subject being captured, it is not possible to perform image capture under exposure conditions appropriate for still image capture and moving image capture, respectively.

### SUMMARY

The present disclosure has been made in consideration of the above situation, and in a case where a still image is captured during moving image capture, the moving image capture and the still image capture are performed under exposure conditions suitable for capturing a moving image and a still image, respectively, without interrupting the moving image.

According to the present disclosure, provided is an image capturing apparatus comprising: an image sensor that captures a subject image and outputs an image signal; one or more processors; and a memory storing instructions which, when the instructions are executed by the one or more processors, cause the image capturing apparatus to function as: a determination unit that determines an exposure period and a sensitivity of the image sensor based on the image signal; and an actuation unit that actuates the image sensor based on the exposure period and the sensitivity determined by the determination unit, wherein the actuation unit is capable of actuating the image sensor in a first mode in which a moving image is captured at a predetermined image capture period, and in a second mode in which a still image can be captured while a moving image is captured at the image capture period, and wherein, in a case where the image sensor is actuated in the second mode, the determination unit determines a first exposure period and a first sensitivity for moving image capture, with a second period, which is a partial period of the image capture period excluding a predetermined first period, as a maximum exposure period for the first exposure period.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a schematic configuration of an image sensor according to one or more aspects of the present disclosure.

FIG. 2 is a diagram illustrating a pixel arrangement of an image sensor according to one or more aspects of the present disclosure.

FIG. 3 is a block diagram illustrating a configuration of an image capturing apparatus according to one or more aspects of the present disclosure.

FIG. 4 is a diagram illustrating an example of a settings screen for simultaneous moving and still image capture according to one or more aspects of the present disclosure.

FIGS. 5A and 5B are timing diagrams of the simultaneous moving and still image capture according to one or more aspects of the present disclosure.

FIG. 6 is a flowchart illustrating the simultaneous moving and still image capture processing according to one or more aspects of the present disclosure.

FIG. 7 is a diagram illustrating an example of an image capture condition priority menu according to one or more aspects of the present disclosure.

FIG. 8 is a timing diagram of the simultaneous moving and still image capture according to one or more aspects of the present disclosure.

FIG. 9 is a timing diagram of the simultaneous moving and still image capture according

to one or more aspects of the present disclosure.

FIG. 10 is a timing diagram of the simultaneous moving and still image capture according to one or more aspects of the present disclosure.

FIG. 11 is a timing diagram of the simultaneous moving and still image capture according to one or more aspects of the present disclosure.

FIG. 12 is a diagram illustrating an example of an exposure period setting menu for still image capture according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

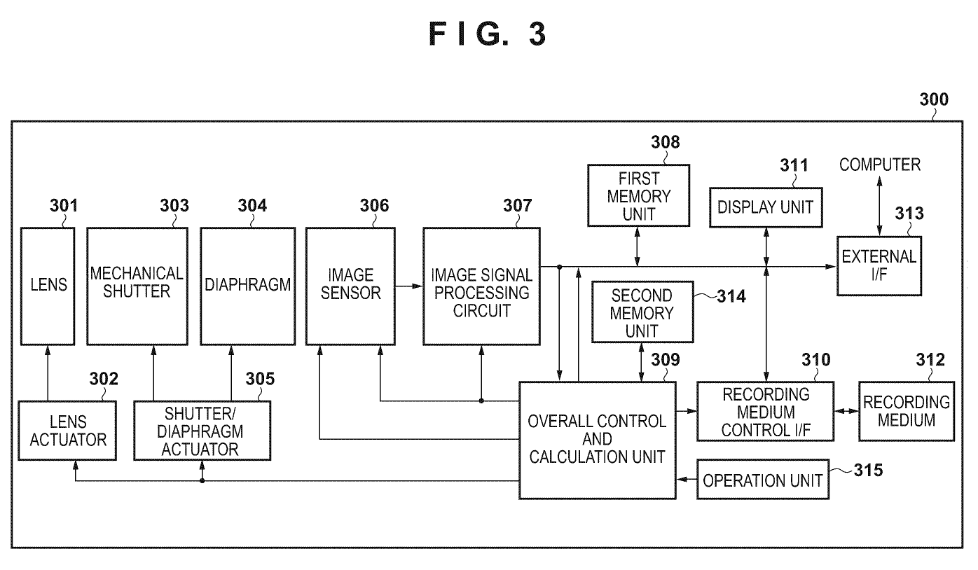

FIG. 3 is a block diagram illustrating the configuration of an image capturing apparatus 300 according to a first embodiment of the present disclosure. The image capturing apparatus 300 according to this embodiment is, for example, a digital camera having a still image capturing function and a moving image capturing function. While the following description uses a digital camera as an example, the present disclosure is not limited thereto and can be applied to any electronic device capable of incorporating an image capturing function. Examples of such electronic devices include video cameras, computer devices (personal computers, tablet computers, media players, PDAs, etc.), mobile phones, smartphones, game consoles, robots, drones, and dashboard cameras. These are merely examples, and the present disclosure can be applied to other electronic devices. The present disclosure can also be applied to a configuration in which a subject detection function and an image capturing function are provided in separate devices capable of communicating with each other (e.g., a main unit and a remote controller).

In FIG. 3, a lens 301 includes a zoom lens, a focus lens, etc., and the focal length and focal position are controlled by a lens actuator 302 actuating the lens 301 under control of an overall control and calculation unit 309. An amount of light of an optical image of a subject that passes through the lens 301 is adjusted so as to be appropriate by a diaphragm 304 while a mechanical shutter 303 is open, and then the optical image enters the imaging surface of an image sensor 306. The mechanical shutter 303 and the diaphragm 304 are actuated and controlled by a shutter/diaphragm actuator 305 under control of the overall control and calculation unit 309. Note that the mechanical shutter 303 is kept retracted from the optical path while LV and moving image capture are being performed.

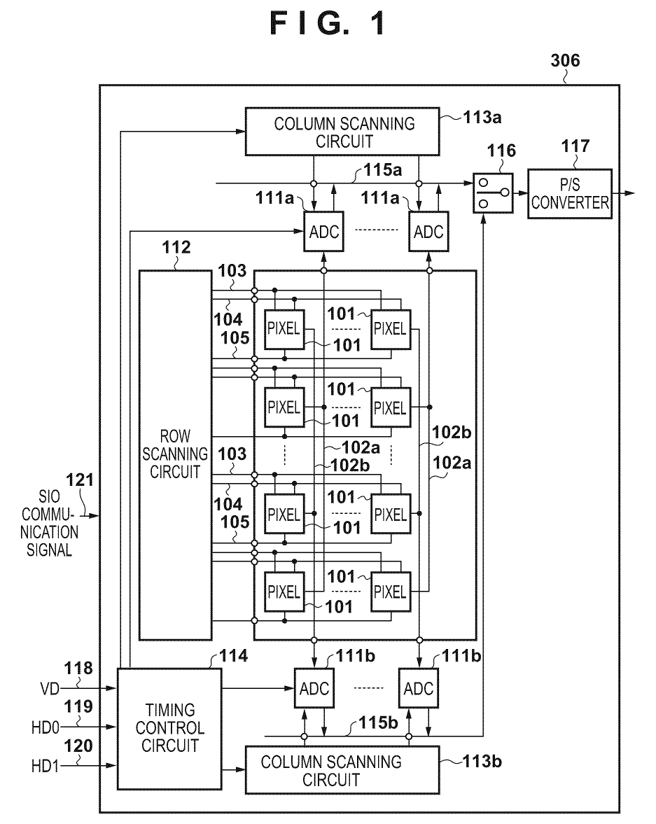

The image of the subject formed on the imaging surface of the image sensor 306 is photoelectrically converted, and then undergoes gain adjustment and A/D conversion to convert an analog signal into a digital signal, and is captured as R, Gr, Gb, and B pixel signals and sent to an image signal processing circuit 307. Details of the image sensor 306 will be described later with reference to FIG. 1.

The image signal processing circuit 307 performs predetermined calculation processing using the obtained image signal, and based on the calculation results, the overall control and calculation unit 309 performs exposure control and focus adjustment control, thereby realizing through-the-lens (TTL) type auto exposure (AE) processing, auto electrical flash (EF) processing, and auto focus (AF) processing.

Here, a method for determining a proper exposure through the AE processing by the overall control and calculation unit 309 will be described. The proper exposure is an exposure amount at which a luminance evaluation value in a predetermined photometric area in an image becomes a predetermined reference value. The luminance evaluation value is generated by performing a predetermined calculation in the image signal processing circuit 307 using an image signal obtained from the image sensor 306. In a typical image capturing apparatus, a photometric area and a method for calculating the luminance evaluation value can be selected from a plurality of modes (photometric modes). For example, there are a mode in which the luminance evaluation value is calculated using the entire image as the photometric area, and a mode in which the luminance evaluation value is calculated by setting the photometric area at the central portion of the image. Note that these methods for calculating the luminance evaluation value are merely examples, and other methods may also be used.

The overall control and calculation unit 309 determines exposure conditions such that the exposure amount is increased in a case where the luminance evaluation value is lower (darker) than the reference value, and the exposure amount is decreased in a case where the luminance evaluation value is higher (brighter) than the reference value. Based on the determined exposure conditions, the overall control and calculation unit 309 adjusts the aperture diameter of the diaphragm 304 and the exposure period by the mechanical shutter 303 using the shutter/diaphragm actuator 305. The overall control and calculation unit 309 also controls the charge reset and readout operation (electronic shutter) of the image sensor 306 to adjust the exposure period, and changes the gain to adjust the image capture sensitivity. In this way, the exposure amount can be increased or decreased.

Further, the image signal processing circuit 307 performs predetermined calculations using the captured image signal and performs TTL auto white balance (AWB) processing based on the calculation results. It also performs defective pixel correction and shading processing depending on the feature of the image sensor 306, followed by development processing. The development processing includes low-pass filtering to reduce noise, sharpness correction to correct subject blur, contrast correction to adjust contrast of an image, and false color correction to correct false color.

The overall control and calculation unit 309 controls the entire image capturing apparatus 300 and performs various calculations.

An operation unit 315 includes various buttons and a touch panel that allow the user to perform settings of the image capturing apparatus 300, and specifically includes a menu button, a release button that commands the start of still image capture, a button that commands the start/stop of moving image capture, and a playback button for checking the captured images. Information related to the operating conditions of the image capturing apparatus 300 that are set by the user operating the operation unit 315 is sent to the overall control and calculation unit 309, and the image capturing apparatus 300 performs control based on this information.

A first memory unit 308 temporarily stores image signals. A second memory unit 314 stores the calculation results of the overall control and calculation unit 309.

A recording medium 312 is a removable storage medium such as a semiconductor memory, and a recording medium control interface (I/F) 310 records and reads image files on/from the recording medium 312.

A display unit 311 displays an image according to the image signal. In this embodiment, the display unit 311 has two types of displays: an electronic view finder (EVF) and a liquid crystal display (LCD).

An external interface (I/F) 313 is an interface for communicating with an external computer, etc.

In the image capturing apparatus 300 having the above configuration, when a user operates the operation unit 315 to instruct to start still image capture, the overall control and calculation unit 309 develops pixel signals obtained from the image sensor 306 using the image signal processing circuit 307. The overall control and calculation unit 309 then temporarily stores the developed pixel signals as still image data in the first memory unit 308, and then records the data as a still image file on the recording medium 312 via the recording medium control interface 310.

Furthermore, when the user operates the operation unit 315 to instruct to start moving image capture, the overall control and calculation unit 309 develops pixel signals obtained at a constant frame rate from the image sensor 306 using the image signal processing circuit 307. The overall control and calculation unit 309 then temporarily stores the developed pixel signals as moving image data in the first memory unit 308, and then records the data as a moving image file on the recording medium 312 via the recording medium control interface 310.

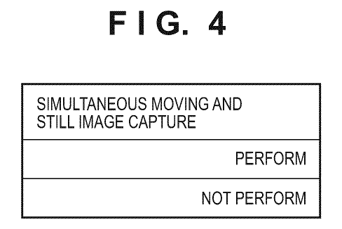

Furthermore, the overall control and calculation unit 309 displays a menu screen on the display unit 311 for selecting whether or not to perform simultaneous moving and still image capture, in response to a user's operation on the operation unit 315. Then, based on the user's instruction on the operation unit 315, the overall control and calculation unit 309 determines whether or not to perform simultaneous moving and still image capture, and stores the determination result in the first memory unit 308. FIG. 4 is a diagram illustrating an example of a setting screen for simultaneous moving and still image capture displayed on the display unit 311.

Next, an example of the configuration of the image sensor 306 will be described with reference to FIG. 1.

The image sensor 306 has a plurality of pixels 101 arranged in a matrix, connected horizontally (in the row direction) by transfer signal lines 103, reset signal lines 104, and row selection signal lines 105, and connected vertically (in the column direction) by vertical output lines 102a and 102b. In the configuration shown in FIG. 1, two vertical output lines 102a and 102b are arranged in each column, with pixels in even rows connected to the vertical output line 102a and pixels in odd rows connected to the vertical output line 102b. With this configuration, signals from pixels in two rows selected by the row selection signal line 105 can be processed in parallel via the vertical output lines 102a and 102b.

The image sensor 306 also has a plurality of column ADC circuits 111a and 111b connected to each column, a row scanning circuit 112, column scanning circuits 113a and 113b, a timing control circuit 114, a changeover switch 116, and a parallel-to-serial (P/S) converter 117.

The timing control circuit 114 controls actuation timing of the image sensor 306 based on a vertical synchronization signal (VD signal) 118, a horizontal synchronization signal 0 (HD0 signal) 119, and a horizontal synchronization signal 1 (HD1 signal) 120 input from the overall control and calculation unit 309. A reference numeral 121 denotes an SIO communication signal.

The changeover switch 116 selects and outputs either the pixel signals output from the column ADC circuits 111a under control of the column scanning circuit 113a to a horizontal signal line 115a, or the pixel signals output from the column ADC circuits 111b under control of the column scanning circuit 113b to a horizontal signal line 115b.

The pixel signals output from the changeover switch 116 are converted from parallel signals to a serial signal by a P/S converter 117 in accordance with the timing of the timing control circuit 114, and the serial signal is sent outside the image sensor 306 (here, to an image signal processing circuit 307).

The image sensor 306 has a standby state, a read state, and an exposure state. During the standby state, pixel signals are not read out from the pixels 101 and are not transferred to the image signal processing circuit 307. During the read state, the pixels 101 are exposed and pixel signals are read out, and the pixel signals are transferred to the image signal processing circuit 307. During the exposure state, pixel signals are not read out from the pixels 101 and are not transferred to the image signal processing circuit 307, and charge is accumulated in the pixels 101.

In addition, the readout actuation of the image sensor 306 can be selected from a readout actuation that reads out pixel signals from all pixels, a readout actuation that thins out the rows vertically to 1/3 or 1/5, an actuation that does not read out upper and/or lower portion of rows, an actuation for 4K, etc.

The configuration shown in FIG. 1 is merely an example, and any image sensor capable of adjusting the timing of resetting and reading out charges and adjusting the gain may be used. While FIG. 1 illustrates a case in which two vertical output lines 102a and 102b are provided for each column, a single vertical output line may be provided for each column. In this case, a single column ADC circuit and column scanning circuit are sufficient, and the changeover switch 116 is not required.

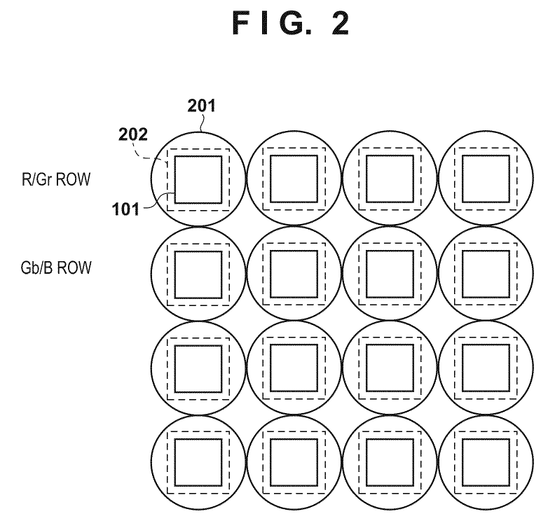

FIG. 2 is a diagram schematically illustrating an arrangement of the pixels 101 in the first embodiment. The color filters 202 are arranged in a Bayer array, and red (R) and green (Gr) color filters 202 are alternately arranged from left to right in odd-numbered rows of pixels. Further, green (Gb) and blue (B) color filters 202 are alternately arranged from left to right in even-numbered rows of pixels. On-chip microlenses 201 are also formed over the color filters 202.

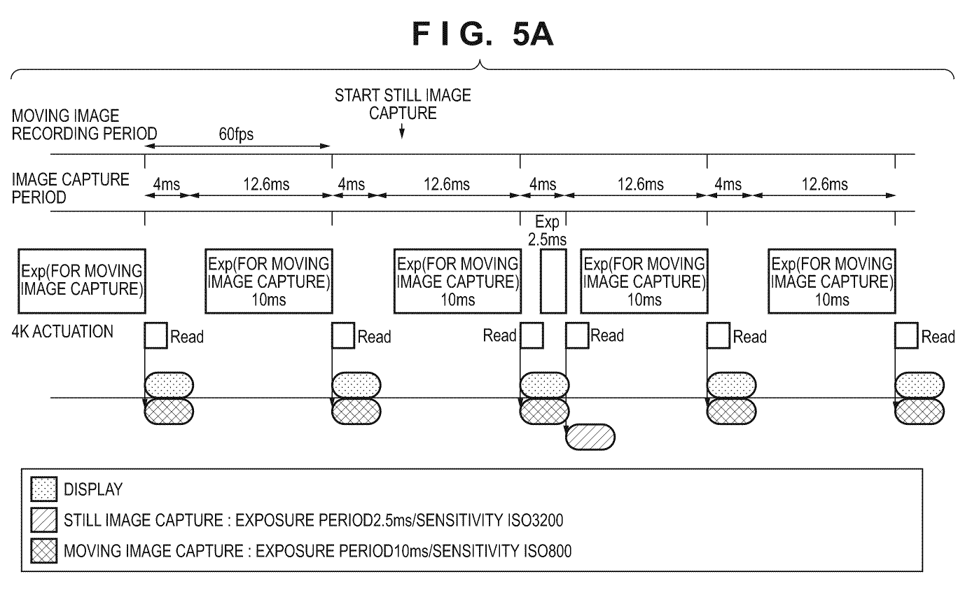

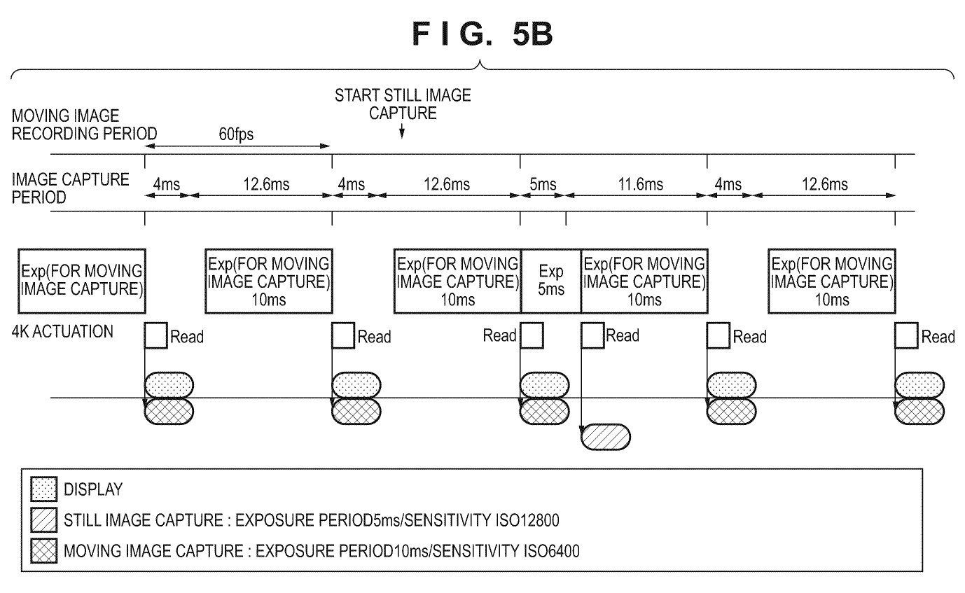

Next, a simultaneous moving and still image capture method according to the first embodiment of the present disclosure will be described with reference to the timing diagrams of FIGS. 5A and 5B. Here, the moving image recording rate is set to 60 fps (moving image recording period: 16.6 ms), and the moving image recording size is set to 4K. When simultaneous moving and still image capture is set to "perform" in FIG. 4, during LV, the image sensor 306 operates for 4K at 60 fps (16.6 ms).

In this embodiment, in a case where simultaneous moving and still image capture is performed, a period of time (reserved period for still image capture) for still image capture is reserved in advance within the 16.6 ms of the moving image recording period, and the remaining period is set as the maximum exposure period for moving image capture (reserved period for moving image capture). In this case, a period longer than the readout period for 4K actuation is reserved as the reserved period for still image capture. As an example, if 4 ms is reserved as the reserved period for still image capture, the maximum exposure period for moving image capture is 12.6ms, calculated by subtracting 4ms from 16.6 ms. In this case, when determining the exposure conditions for moving image capture, the aperture value and sensitivity are determined so that the exposure period is 12.6ms or less.

When an instruction to start capturing a moving image is issued in response to user operation of the operation unit 315, the overall control and calculation unit 309 performs AE processing. In the AE processing, the exposure conditions for moving image capture, including the exposure period of the image sensor 306, are determined, and the aperture diameter of the diaphragm 304 and the exposure period and sensitivity (gain) of the image sensor 306 are controlled based on the determined exposure conditions. Then, the overall control and calculation unit 309 starts moving image capture after controlling the exposure.

Thereafter, when the user operates the operation unit 315 to instruct still image capture during the moving image capture, the overall control and calculation unit 309 performs AE processing and determines exposure conditions for still image capture. At this time, it is preferable to set the exposure period for the still image capture to be sufficiently short to reduce subject blur. Furthermore, in the AE processing by the overall control and calculation unit 309, the total period of the exposure period for moving image capture and the exposure period for still image capture may be limited so as not to exceed the moving image recording period.

Then, it is determined whether the total period of the exposure period for the moving image capture and the exposure period for the still image capture exceeds the moving image recording period.

FIG. 5A shows a case where the exposure period for moving image capture is 10 ms and the sensitivity is ISO 800, and the exposure period for still image capture is set to 2.5ms and the sensitivity is set to ISO 3200 as a result of the AE processing performed by the overall control and calculation unit 309 during still image capture. In this case, the total of the exposure period of 2.5ms for the still image capture and the exposure period 10 ms for the moving image capture is 12.5 ms, which does not exceed the moving image recording period of 16.6 ms, so the exposure conditions for the moving image capture are not changed and the set exposure conditions for the still image capture are used.

Next, the overall control and calculation unit 309 sets the image sensor 306 to an exposure period for the still image capture of 2.5 ms, changes the sensitivity to ISO 3200, and performs the still image capture by reading out image data. At this time, the start timing (charge reset timing) of the exposure period of 2.5ms is controlled so that the still image signal is read out at the end of the reserved period for still image capture of 4 ms. In other words, exposure for the still image capture starts 1.5 ms after the start of the moving image recording period of 16.6 ms. By controlling in this way, in a case where the exposure period for still image capture is 4 ms or less, the still image signal can be read out at the same timing in each moving image recording period of 16.6 ms.

Next, the overall control and calculation unit 309 changes the settings of the image sensor 306 to an exposure period of 10 ms and sensitivity of ISO 800 for moving image capture, acquires image data, and continues moving image capture.

Next, a case will be described in which an exposure period for still image capture exceeds the reserved period for still image capture of 4 ms as a result of AE processing by the overall control and calculation unit 309.

FIG. 5B shows a case where the exposure period for moving image capture is 10 ms and the sensitivity is ISO 6400, and the exposure period for still image capture is set to 5 ms and the sensitivity is set to ISO 12800 as a result of the AE processing performed by the overall control and calculation unit 309 during still image capture. Because the amount of noise in an image tends to increase as the sensitivity increases, this example shows a case where the exposure period is lengthened to reduce the shooting sensitivity as much as possible. In this case, the total of the exposure period of 5 ms for the still image capture and the exposure period of 10 ms for the moving image capture is 15 ms, which does not exceed the period of 16.6 ms of the moving image recording rate of 60 fps, so the exposure conditions for the moving image capture are not changed and the set exposure conditions for the still image capture can be used.

However, since the exposure period for the still image capture is 5 ms, if the image signal of the still image is read out at the end of the reserved period for still image capture of 4 ms, the exposure period cannot be set to 5 ms. Therefore, if the exposure period for still image capture exceeds the reserved period for still image capture of 4 ms, the timing of reading out the image data of the still image is shifted to a timing later than the reserved period for still image capture of 4 ms.

In this way, the overall control and calculation unit 309 controls the image sensor 306 with the exposure period of 5ms, changes the sensitivity to ISO 12800 for the still image capture, and performs still image capture by reading out image data.

Next, the overall control and calculation unit 309 changes the settings of the image sensor 306 to the exposure period of 10 ms and the sensitivity of ISO 800 for moving image capture. At this time, the maximum exposure period remaining for the moving image capture of the image sensor 306 is 11.6ms, obtained by subtracting the exposure period of 5 ms for the still image capture from the moving image recording period of 16.6 ms.

Furthermore, if the result of AE processing by the overall control and calculation unit 309 is that the total of the exposure period for still image capture and the exposure period for moving image capture exceeds the moving image recording period, the exposure conditions for the still image capture and the moving image capture are changed so that the total of the exposure period for the still image capture and the exposure period for the moving image capture does not exceed the moving image recording period. Here, the exposure periods are shortened by increasing the sensitivities for both still image capture and moving image capture, so that the total of the exposure period for the still image capture and the exposure period for the moving image capture does not exceed the moving image recording period. At this time, the exposure periods and the sensitivities are changed so that the change in the exposure value of each of the still image capture and the moving image capture is small.

If it is desired to make the exposure period for moving image capture longer than 12.6ms, the image sensor 306 may be operated at a rate changed from 60 fps to 30 fps (33.3 ms).

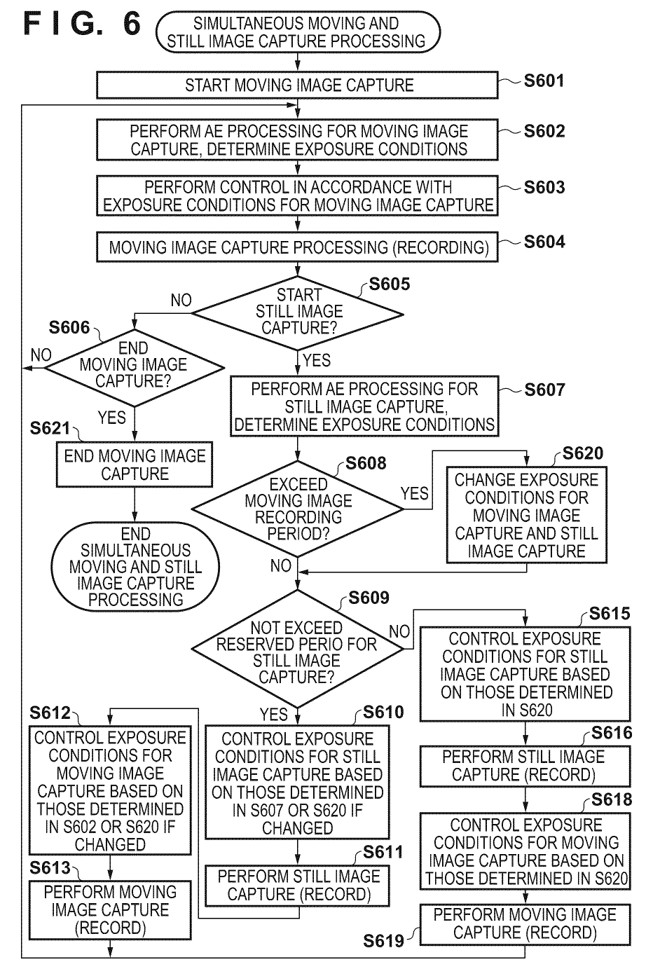

FIG. 6 is a flowchart illustrating the simultaneous moving and still image capture processing in the first embodiment of the present disclosure.

When the simultaneous moving and still image capture is set to "perform" on the setting screen shown in FIG. 4 and the user operates the operation unit 315 to instruct the start of moving image capture, in step S601 the overall control and calculation unit 309 starts moving image capture.

In step S602, AE processing for moving image capture is performed to determine the exposure conditions for moving image capture (aperture value, exposure period, and sensitivity). At this time, as described above, the exposure period for moving image capture is determined after reserving the reserved period for still image capture in the moving image recording period.

Next, in step S603, the diaphragm 304 and the image sensor 306 are controlled in accordance with the aperture value, exposure period, and sensitivity determined in step S602.

Then, in step S604, the image signal processing circuit 307 performs sensitivity (gain) adjustment and development processing on the pixel signals obtained from the image sensor 306, and temporarily records the moving image in the first memory unit 308 at a constant frame rate, while recording the moving image file on the recording medium 312.

Next, in step S605, the overall control and calculation unit 309 determines whether or not still image capture is instructed by a user operation on the operation unit 315. If it is determined in step S605 that still image capture is not instructed, the overall control and calculation unit 309 determines in step S606 whether or not an end of the moving image capture is instructed by a user operation on the operation unit 315. If an end of the moving image capture is not instructed in step S606, the process returns to step S602, and if an end of the moving image capture is instructed, the process proceeds to step S621 to end the moving image capture and end the simultaneous moving and still image capture processing.

On the other hand, if it is determined in step S605 that still image capture is instructed, AE processing for the still image capture is performed in step S607 to determine the exposure conditions for the still image capture (aperture value, exposure period, and sensitivity). Regarding the aperture value, because moving image capture is performed immediately after the still image capture, it is preferable to use the aperture value used during the moving image capture without changing it. There is no specific method for determining the exposure conditions for the still image capture; any known method may be used. However, to reduce subject blur, it is preferable to determine exposure conditions that shorten the exposure period for the still image capture. In this case, the exposure period for the still image capture may be set to within a period remaining after subtracting the exposure period for the moving image capture from the moving image recording period and the insufficient exposure period may be compensated for by the sensitivity. In this case, the determination in step S608, described below, will always be YES. Further, because excessively high sensitivity can result in excessive noise, for example, an upper limit of the sensitivity may be determined in advance, and the exposure period may be determined so as not to exceed the upper limit of the sensitivity.

Next, in step S608, it is determined whether the total exposure period of the still image capture and the moving image capture exceeds the moving image recording period. If it is determined that the total exposure period does not exceed the moving image recording period, the process proceeds to step S609, and if it is determined that the total exposure period exceeds the moving image recording period, the process proceeds to step S620.

In step S620, the exposure conditions for the moving image capture and the still image capture are changed. At this time, the total exposure period of the exposure period for the moving image capture and the exposure period for the still image capture is controlled so as not to exceed the moving image recording period. Specifically, the exposure periods are shortened by increasing the sensitivities, so that the total exposure period of the exposure period for the moving image capture and the exposure period for the still image capture does not exceed the moving image recording period.

Next, in step S609, it is determined whether the exposure period for the still image capture exceeds the reserved period for still image capture. If it does not exceed the period, the process proceeds to step S610, and if it does exceed the period, the process proceeds to step S615.

In step S610, the exposure period and sensitivity of the image sensor 306 are controlled based on the exposure conditions for the still image capture determined in step S607 or S620.

Then, in step S611, the pixel signals obtained from the image sensor 306 are developed by the image signal processing circuit 307 and temporarily stored as still image data in the first memory unit 308, and then recorded as a still image file on the recording medium 312.

Next, in step S612, the exposure period and sensitivity of the image sensor 306 are controlled based on the exposure conditions for the moving image capture determined in step S602 or S620.

Then, in step S613, the pixel signals obtained from the image sensor 306 are developed by the image signal processing circuit 307, and while the developed signals are temporarily stored in the first memory unit 308 as moving image data, they are also recorded on the recording medium 312 as a moving image file, and the process returns to step S602.

On the other hand, in step S615, the exposure period and sensitivity of the image sensor 306 are controlled based on the exposure conditions for the still image capture changed in step S620. At this time, as explained with reference to FIG. 5B, the exposure period exceeds the reserved period for still image capture, so control is performed so that the readout timing occurs after the reserved period for still image capture.

Next, in step S616, the pixel signals obtained from the image sensor 306 are developed by the image signal processing circuit 307, and the developed signals are temporarily stored in the first memory unit 308 as still image data, and then recorded as a still image file on the recording medium 312.

Thereafter, in step S618, the exposure period and sensitivity of the image sensor 306 are controlled based on the exposure conditions for the moving image capture changed in step S620.

Next, in step S619, the pixel signals obtained from the image sensor 306 are developed by the image signal processing circuit 307, and while the developed signals are temporarily stored in the first memory unit 308 as moving image data, they are also recorded on the recording medium 312 as a moving image file, and the process returns to step S602.

As described above, according to the first embodiment, in a case where still image capture is performed during moving image capture, it is possible to perform still image capture and moving image capture under exposure conditions suitable for still image capture and moving image capture, respectively, without interrupting the moving image capture.

### Second Embodiment

Next, a second embodiment of the present disclosure will be described.

The image capturing apparatus according to the second embodiment is the same as that described in the first embodiment with reference to FIGS. 1 to 3, and therefore description thereof will be omitted here. Furthermore, the flow of the simultaneous moving and still image capture processing in the second embodiment is also the same as that described in the first embodiment with reference to FIG. 6, and therefore will not be described here.

In the first embodiment, if the total period of the exposure period for still image capture and the exposure period for moving image capture exceeds the moving image recording period (YES in step S608), AE processing for the still image capture and the moving image capture is performed again, and the exposure conditions for the still image capture and the moving image capture are changed (step S620). At this time, it has been described that the exposure periods are shortened by increasing the sensitivities for both the still image capture and the moving image capture, so that the total period of the exposure period for the still image capture and the exposure period for the moving image capture does not exceed the moving image recording period.

In the second embodiment, a configuration will be described in which, if the total period of the exposure period for still image capture and the exposure period for moving image capture exceeds the moving image recording period, the exposure conditions for the still image capture and the moving image capture are changed using a method different from that of the first embodiment.

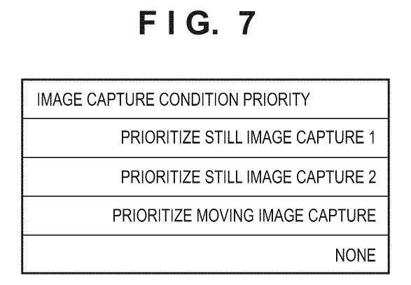

FIG. 7 is a diagram illustrating a menu (image capture condition priority menu) for setting which image capture condition should be prioritized in a case where the total period of the exposure period for still image capture and the exposure period for moving image capture exceeds the moving image recording period while the simultaneous moving and still image capture is performed in the second embodiment.

The overall control and calculation unit 309 displays a menu screen of the image capture condition priority menu for the simultaneous moving and still image capture on the display unit 311 in response to user operations on the operation unit 315. In the menu screen, choices of "prioritize still image capture 1" (first priority mode), "prioritize still image capture 2" (second priority mode), "prioritize moving image capture" (third priority mode), or none (fourth priority mode) are displayed, and the choice selected by user operations on the operation unit 315 is stored in the first memory unit 308.

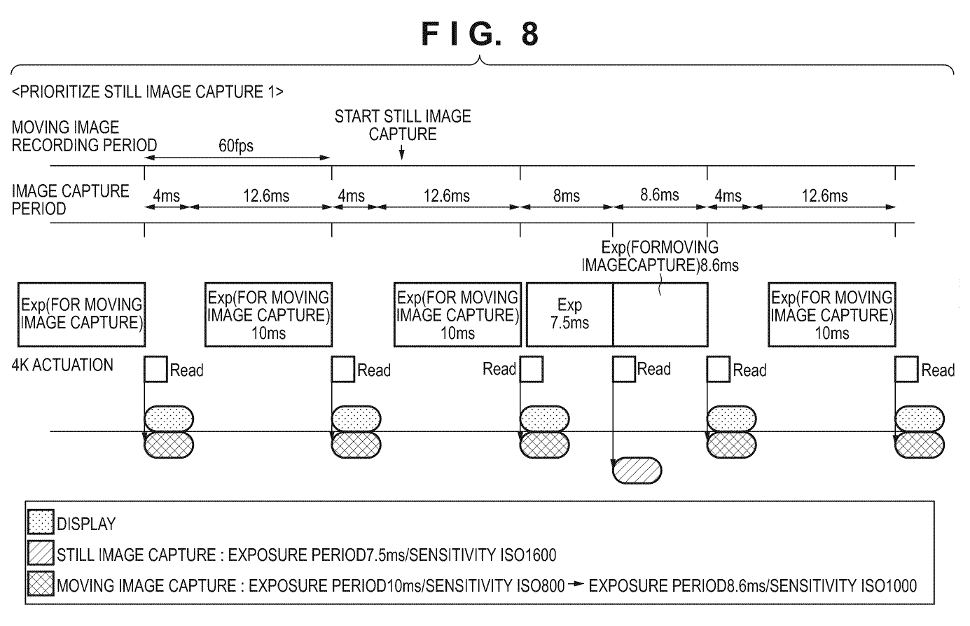

FIG. 8 is a timing diagram in a case where "prioritize still image capture 1" is selected in the image capture condition priority menu during the simultaneous moving and still image capture according to the second embodiment of the present disclosure.

In FIG. 8, the moving image recording rate is 60 fps (moving image recording period 16.6 ms), and the recording size of the moving image capture is 4K. Furthermore, within the 16.6 ms of the moving image recording period, the reserved period for still image capture is 4 ms, and the reserved period for moving image capture (maximum exposure period for moving image capture) is 12.6ms, as in the examples shown in FIGS. 5A and 5B. Furthermore, it is assumed that the exposure period for moving image capture is set to 10 ms and the sensitivity is set to ISO 800 by AE control for moving image capture.

When still image capture is instructed by the user operating the operation unit 315 during moving image capture, the overall control and calculation unit 309 performs AE processing and determines the exposure conditions for still image capture. The example shown in FIG. 8 illustrates a case where the exposure period for still image capture is set to 7.5ms and the sensitivity to ISO 1600 based on the AE processing results by the overall control and calculation unit 309 during still image capture.

Then, it is determined whether the total exposure period of the exposure period for moving image capture and the exposure period for still image capture exceeds the moving image recording period. In the example shown in FIG. 8, the total exposure period of the exposure period for still image capture (7.5ms) and the exposure period for moving image capture (10 ms) is 17.5 ms, which exceeds the moving image recording period of 16.6 ms, so the exposure conditions for the still image capture and the moving image capture are changed.

In the example shown in FIG. 8, "prioritize still image capture 1" is selected in the image capture condition priority menu shown in FIG. 7, so the exposure conditions for still image capture are not changed, and the exposure period for the moving image capture is changed from 10 ms to 8.6 ms (within 16.6 ms - 7.5ms = 9 ms), and the sensitivity is changed from ISO 800 to ISO 1000. At the same time, of the moving image recording period of 16.6 ms, 8ms is assigned as the reserved period for still image capture and 8.6ms is assigned as the reserved period for moving image capture, and the exposure start timing is controlled. Changing the exposure conditions for moving image capture may result in differences in the amount of noise and the amount of subject blur compared to the moving image of the previous frame, but still image capture can be performed under appropriate exposure conditions.

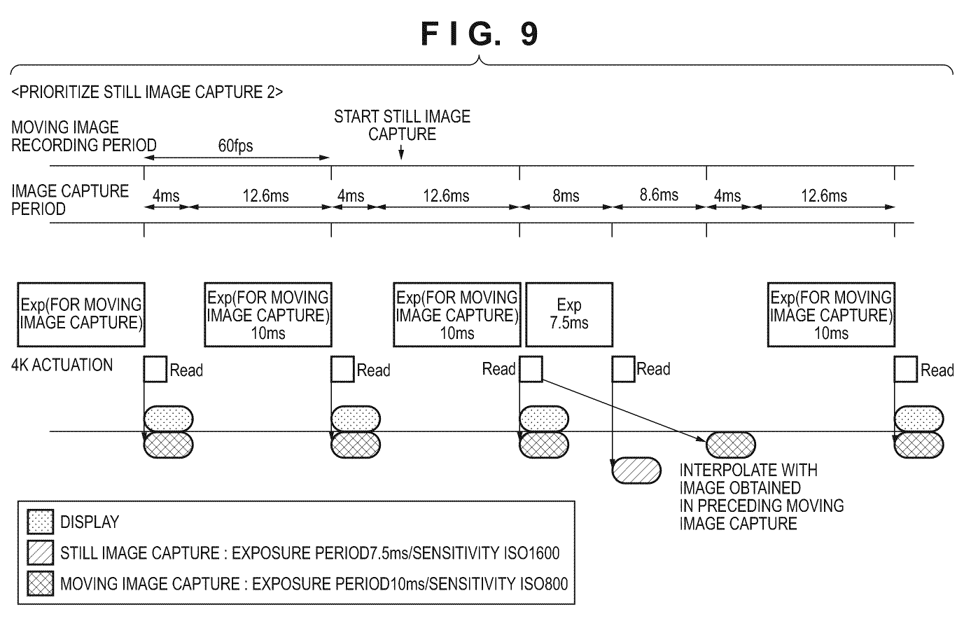

FIG. 9 illustrates the operation in a case where "prioritize still image capture 2" is selected in the image capture condition priority menu shown in FIG. 7 under the same conditions as those of FIG. 8. If "prioritize still image capture 2" is selected, neither the exposure conditions for still image capture nor the exposure conditions for moving image capture are changed. However, if "prioritize still image capture 2" is selected, moving image capture is not performed after still image capture, and the missing frame of the moving image is interpolated using moving image data of the preceding frame.

Since moving image data is interpolated with image data of the preceding frame, the recorded moving image file appears as if the frame has stopped for an instant, but still image capture can be performed under appropriate exposure conditions.

In the example of FIG. 9, the interpolation is performed using the moving image data of the preceding frame, but the interpolation method is not limited to this. For example, the interpolation may be performed using the moving image data of the preceding and next frames, or using image data obtained by still image capture, or a single color image such as a black image may be inserted so that it is clear that a still image capture has been performed. Any arbitrary method may be used.

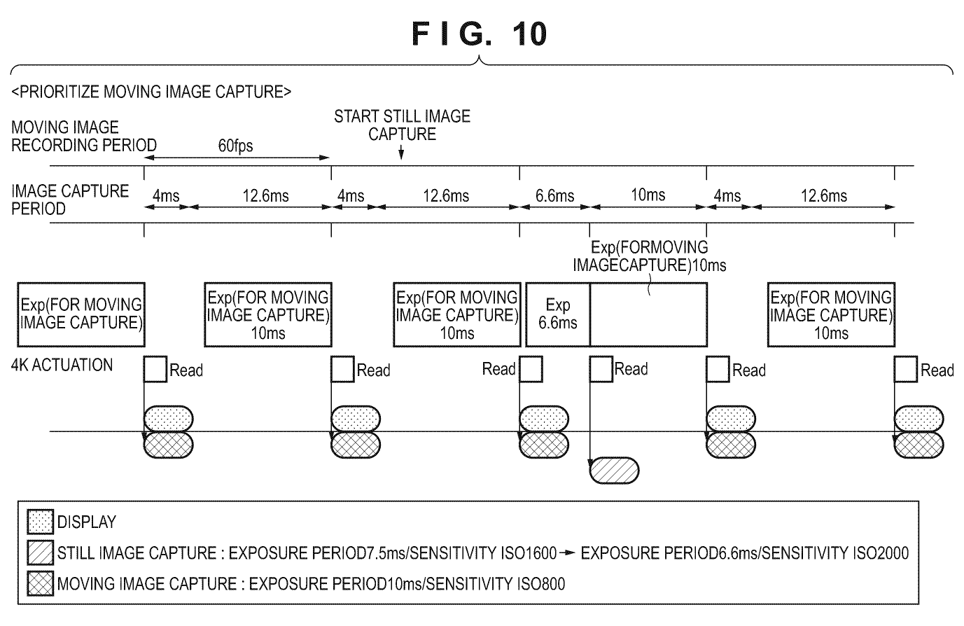

FIG. 10 is a diagram illustrating the operation in a case where "prioritize moving image capture" is selected in the image capture condition priority menu shown in FIG. 7 under the same conditions as those of FIG. 8. If "prioritize moving image capture" is selected, the exposure conditions for moving image capture are not changed, the exposure period for still image capture is changed from 7.5ms to 6.6ms (within 16.6 ms - 10 ms = 6.6ms), and the sensitivity is changed from ISO 1600 to ISO 2000.

Changing exposure conditions for still image capture can sometimes make it impossible to capture a still image with the appropriate exposure, or can result in an image with increased noise, but moving image capture can be performed with the appropriate exposure conditions.

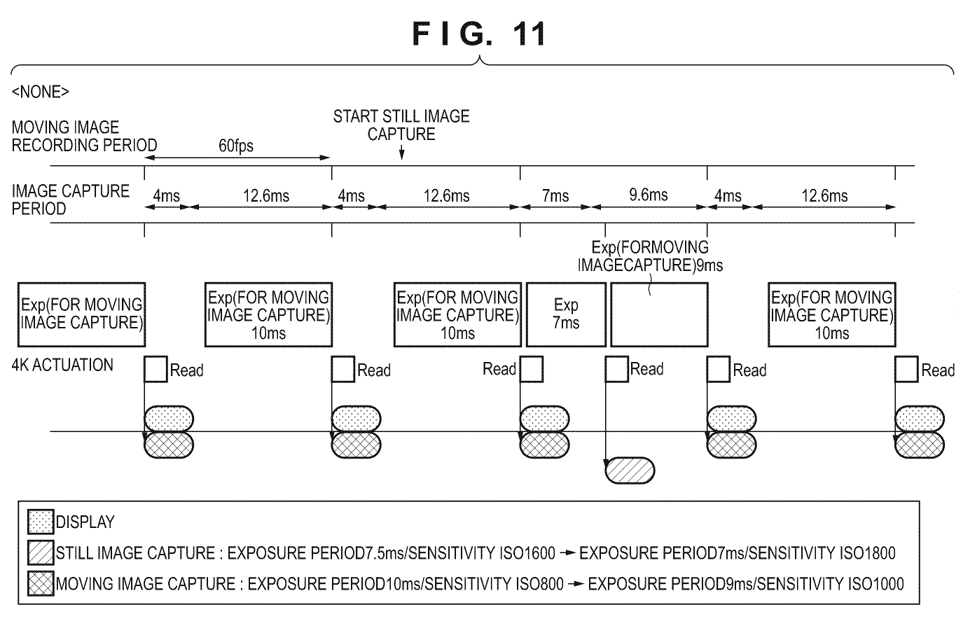

FIG. 11 illustrates the operation in a case where "none" is selected in the image capture condition priority menu shown in FIG. 7 under the same conditions as those of FIG. 8. If "none" is selected, the exposure period for still image capture is changed from 7.5ms to 7.0 ms, and the sensitivity is changed from ISO 1600 to ISO 1800. Furthermore, the exposure period for moving image capture is changed from 10 ms to 9 ms, and the sensitivity is changed from ISO 800 to ISO 1000. This method corresponds to the method in the first embodiment in which the total exposure period is controlled within the moving image recording period by shortening the exposure periods and increasing the sensitivities.

By changing the exposure conditions for moving image capture and still image capture, it is possible to perform both moving image capture and still image capture with appropriate exposure amounts. However, by increasing the sensitivities, the images will have more noise, but it is possible to avoid the image quality of either image being extremely poor.

As described above, according to the second embodiment, in a case where still image capture is performed during moving image capture, if the total exposure period of the exposure period for still image capture and the exposure period for moving image capture exceeds the moving image recording period, the user can select which exposure condition to prioritize. This makes it possible to perform moving image capture and still image capture according to the user's intention.

### Third Embodiment

Next, a third embodiment of the present disclosure will be described.

The image capturing apparatus according to the third embodiment is the same as that described in the first embodiment with reference to FIGS. 1 to 3, and therefore description thereof will be omitted here. Furthermore, the flow of the simultaneous moving and still image capture processing in the third embodiment is also the same as that described in the first embodiment with reference to FIG. 6, and therefore will not be described here.

In the first and second embodiments, the exposure period for still image capture and the exposure period for moving image capture can be freely changed. In the third embodiment, a configuration will be described in which the exposure period for still image capture is limited within a pre-fixed range.

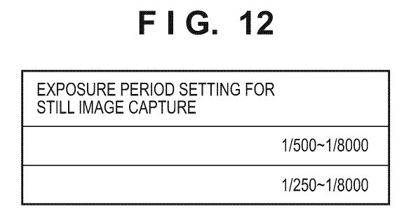

FIG. 12 illustrates a menu (exposure period setting menu for still image capture) for setting the exposure period for still image capture during the simultaneous moving and still image capture in the third embodiment.

In response to a user's operation on the operation unit 315, the overall control and calculation unit 309 displays on the display unit 311 a menu screen of the exposure period setting menu for still image capture during the simultaneous moving and still image capture.

The menu screen displays a menu for selecting the exposure period for still image capture, and the overall control and calculation unit 309 receives instructions corresponding to the user's operation on the operation unit 315 and stores the selected setting in the first memory unit 308.

When a still image capture is instructed by the user through operation on the operation unit 315 during moving image capture, the overall control and calculation unit 309 performs AE processing to determine the exposure conditions for still image capture. At this time, in the AE processing by the overall control and calculation unit 309, the exposure period is determined within the range of the exposure period for still image capture stored in the first memory unit 308.

Then, the overall control and calculation unit 309 determines whether the total exposure period of the exposure period for moving image capture and the exposure period for still image capture exceeds the moving image recording period, and if so, the exposure conditions for still image capture and moving image capture are changed by performing the AE processing by the overall control and calculation unit 309. Here, in the third embodiment, because there is a limit to the exposure period for still image capture, the exposure conditions for moving image capture are changed with priority.

In this case, in the AE processing by the overall control and calculation unit 309, it is possible to set a limit on the exposure period for moving image capture so that the total exposure period of the exposure period for moving image capture and the exposure period for still image capture do not exceed the moving image recording period.

As described above, according to the third embodiment, when still image capture is performed during moving image capture, the user can instruct the exposure period for still image capture, making it possible to perform still image capture in accordance with the user's intentions.

### Other Embodiments

The present disclosure may be applied to a system made up of a plurality of devices, or to an apparatus made up of a single device.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-024487, filed February 18, 2025 which is hereby incorporated by reference herein in its entirety.

What is claimed is:

1. An image capturing apparatus comprising:
an image sensor that captures a subject image and outputs an image signal;
one or more processors; and
a memory storing instructions which, when the instructions are executed by the one or more processors, cause the image capturing apparatus to function as:
a determination unit that determines an exposure period and a sensitivity of the image sensor based on the image signal; and
an actuation unit that actuates the image sensor based on the exposure period and the sensitivity determined by the determination unit,
wherein the actuation unit is capable of actuating the image sensor in a first mode in which a moving image is captured at a predetermined image capture period, and in a second mode in which a still image can be captured while a moving image is captured at the image capture period, and
wherein, in a case where the image sensor is actuated in the second mode, the determination unit determines a first exposure period and a first sensitivity for moving image capture, with a second period, which is a partial period of the image capture period excluding a predetermined first period, as a maximum exposure period for the first exposure period.

2. The image capturing apparatus according to claim 1, wherein in a case where the second mode is set and still image capture is instructed during capturing a moving image based on the first exposure period and the first sensitivity,
the determination unit
determines a second exposure period and a second sensitivity for still image capture,
determines whether a total period of the first exposure period and the second exposure period exceeds the image capture period, and
if the total period exceeds the image capture period, shortens at least one of the first exposure period and the second exposure period so that the total period does not exceed the image capture period, and changes and re-determines at least one of the first sensitivity and the second sensitivity so that changes in an exposure value for the moving image capture and an exposure value for the still image capture are small, and
the actuation unit actuates, during the image capture period, the image sensor to capture a moving image using the determined first exposure period and first sensitivity and to capture a still image using the determined second exposure period and second sensitivity.

3. The image capturing apparatus according to claim 2, wherein in a case where the determined second exposure period is longer than the first period, the first period is lengthened so as to include the second exposure period and the second period is shortened while capturing a still image.

4. The image capturing apparatus according to claim 2, wherein in a case where a first priority mode that prioritizes still image capture is set, the determination unit does not change the second exposure period and the second sensitivity.

5. The image capturing apparatus according to claim 4, wherein in a case where a second priority mode that is different from the first priority mode and prioritizes still image capture is set, and a total period of the first exposure period and the second exposure period exceeds the image capture period, the actuation unit performs still image capture without changing the second exposure period and the second sensitivity, and does not perform moving image capture in a frame of the image capture period in which the still image capture is performed.

6. The image capturing apparatus according to claim 5, wherein the frame of the moving image in which moving image capture is not performed is interpolated using an image of another frame of the moving image.

7. The image capturing apparatus according to claim 5, wherein a single-color image data is inserted as an image of the frame of the moving image in which moving image capture is not performed.

8. The image capturing apparatus according to claim 2, wherein in a case where a third priority mode that prioritizes moving image capture is set, in the second mode, the determination unit does not change the first exposure period and the first sensitivity.

9. The image capturing apparatus according to claim 2, wherein in a case where a fourth priority mode that prioritizes neither still image capture nor moving image capture is set, and a total period of the first exposure period and the second exposure period exceeds the image capture period, the determination unit changes the first exposure period and the first sensitivity, and the second exposure period and the second sensitivity.

10. The image capturing apparatus according to claim 2, wherein the instructions, stored in the memory, which, when the instructions are executed by the one or more processors, cause the image capturing apparatus to further function as a setting unit that sets a range of an exposure period for still image capture,
wherein the determination unit sets the second exposure period within the range of the exposure period set by the setting unit.

11. A control method of an image capturing apparatus having an image sensor that captures a subject image and outputs an image signal, comprising:
determining an exposure period and a sensitivity of the image sensor based on the image signal; and
actuating the image sensor based on the exposure period and the sensitivity determined,
wherein in actuating the image sensor, the image sensor can be actuated in a first mode in which a moving image is captured at a predetermined image capture period, and in a second mode in which a still image can be captured while a moving image is captured at the image capture period, and
wherein, in a case where the image sensor is actuated in the second mode, a first exposure period and a first sensitivity for moving image capture are determined with a second period, which is a partial period of the image capture period excluding a predetermined first period, as a maximum exposure period for the first exposure period.

12. The control method according to claim 11, further comprising:
in a case where the second mode is set and still image capture is instructed during capturing a moving image based on the first exposure period and the first sensitivity,
in the determination,
determining a second exposure period and a second sensitivity for still image capture,
determining whether a total period of the first exposure period and the second exposure period exceeds the image capture period, and
if the total period exceeds the image capture period, shortening at least one of the first exposure period and the second exposure period so that the total period does not exceed the image capture period, and changing and re-determining at least one of the first sensitivity and the second sensitivity so that changes in an exposure value for the moving image capture and an exposure value for the still image capture are small, and
in actuating the image sensor, during the image capture period, actuating the image sensor to capture a moving image using the determined first exposure period and first sensitivity and to capture a still image using the determined second exposure period and second sensitivity.

13. A non-transitory computer-readable storage medium, the storage medium storing instructions when executed by a computer, cause the computer to perform a control method of an image capturing apparatus having an image sensor that captures a subject image and outputs an image signal, the method comprising:
determining an exposure period and a sensitivity of the image sensor based on the image signal; and
actuating the image sensor based on the exposure period and the sensitivity determined,
wherein in actuating the image sensor, the image sensor can be actuated in a first mode in which a moving image is captured at a predetermined image capture period, and in a second mode in which a still image can be captured while a moving image is captured at the image capture period, and
wherein, in a case where the image sensor is actuated in the second mode, a first exposure period and a first sensitivity for moving image capture are determined with a second period, which is a partial period of the image capture period excluding a predetermined first period, as a maximum exposure period for the first exposure period.
